(19) United States
(12) Patent Application Publication
(10) Pub. No.: US 2012/0068535 A1
(43) Pub. Date: Mar. 22, 2012

(54) ENERGY CONVERTER, AND ASSOCIATED METHOD, FOR PROVIDING CONVERTED ENERGY TO A SET OF ELECTRONIC DEVICES

(75) Inventors: Theodore P. Homan, Fort Worth, TX (US); Yi Tsang Wong, Laguna City (HK)

(73) Assignee: RADIOSHACK CORPORATION, Fort Worth, TX (US)

(21) Appl. No.: 12/885,901

(22) Filed: Sep. 20, 2010

(51) Int. Cl. H02J 4/00

(52) U.S. Cl. 307/31

(57) ABSTRACT

An apparatus, and an associated method, converts input energy, such as energy sourced at a household electric power supply, into converted energy for powering a set of electronic devices having operating power requirements. A converter housed in a converter housing forms first-converted energy of the input energy. The first-converted energy is provided to a dongle, connected to the converter. The dongle forms second-converted energy and provides connections to power both a first electronic device with the first-converted energy and to power a second electronic device, having second energy requirements, using second-converted energy formed at the dongle.

The present invention relates generally to a manner by which to provide converted energy to a set of electronic devices, such as a set including a laptop computer and a second, portable electronic device, each having its own energy requirements. More particularly, the present invention relates to an apparatus, and an associated method, by which to provide for in-line power conversion of power of a primary power supply, in which a first conversion is made of the primary power and then, in-line with the first conversion, a second conversion is made.

Improved efficiency and adaptability is provided by the in-line energy conversion, first to provide first-converted energy as a direct output, based directly on primary power of the primary power supply. A second conversion, to form second-converted energy, is performed if a second electronic device, having second energy requirements, is to be powered.

### BACKGROUND OF THE INVENTION

Many new, consumer electronic devices have been developed and made available for consumer purchase and use. Such consumer electronic devices provide many varied functionalities including, e.g., data manipulation, data communication, and data storage functions.

Many of these consumer electronic devices are small and lightweight, readily carried by a user and powered by portable power supplies, such as battery power supplies. A consumer electronic device often times includes electronic circuitry that is powered by relatively low-voltage, direct-current energy. The precise voltage and current levels are device-dependent, and different devices require different energy levels, voltage and current levels, for their operation. When powered by battery power supplies, or the like, the energy provided by such portable power supplies is closely matched to the energy requirements of the electronic circuitry of the device that the battery power supply powers.

The stored energy of a battery, or other portable, power supply is finite. And, the stored energy dissipates through powering of the electronic device. When the stored energy is depleted beneath a suitable level, the electronic device can no longer be powered with the stored energy of the battery power supply. And, the stored energy of the battery power supply must be replenished, or the battery power supply must be replaced with a battery power supply with adequate amounts of stored energy.

Many consumer electronic devices of these types provide for connection to an external source of power, such as a power source at a household power outlet. When so-sourced, the energy of the household, power outlet must be converted to provide for the recharging of the battery power supply or, alternately, powering of the electronic circuitry of the electronic device. Often times, a converter is provided that converts the high-level, alternating-current voltage of a typical household outlet into low-voltage, direct-current energy, amenable for application to the battery power supply or to the electronic circuitry.

Sometimes, a user of an electronic device prefers to power the device with its portable power supply, when a permanent power supply is not available and otherwise power the electronic device with a permanent power supply. That is to say, when the permanent power supply is available, the electronic device is powered by the household power supply. And, when the household power supply is not readily available, the device is powered by its battery power supply. Also, when the electronic device is powered by the energy source at the household power outlet, the batteries of the battery power supply are also recharged.

A user might have two or more of the electronic devices. For instance, a user might have both a laptop computer and also a portable music player, portable camera, portable digital assistant, etc. Both of the devices contain battery power supplies, each of which needing to have its stored energy replenished after use of the respective devices.

While existing converter apparatus is available separately to power, and recharge, the separate electronic devices, such conventional apparatus requires redundant devices to perform the separate conversion and the charging operations and results in a multiplicity of cables that is sometimes cumbersome and inconvenient. And, at least one converter apparatus provides for energy conversion and recharging and powering of separate devices using converter circuitry housed in a single housing. In some jurisdictions, however, there is a preference to not have more than one power tap from a primary power source.

A need remains, therefore, to provide an improved converter, capable of converting input energy to provide energy appropriate for powering separate electronic devices.

It is in light of this background information related to the powering of consumer electronic devices that the significant improvements of the present invention have evolved.

### SUMMARY OF THE INVENTION

The present invention, accordingly, advantageously provides an apparatus, and an associated method, which to provide converted energy to a set of electronic devices, such as a set including a laptop computer and a second, portable electronic device, which each has its own energy requirements.

Through operation of an embodiment of the present invention, a manner is provided by which to provide for in-line power conversion of power of a primary power supply in which a first conversion is made of the primary power and then, in-line with the first conversion, a second conversion is made.

In one aspect of the present invention, improved efficiency and adaptability is provided by the in-line energy conversion. First, a first-converted energy is provided as a direct output, based directly on primary power of a primary power supply. A second conversion is performed to form a second-converted energy, if a second electronic device, having second energy requirements, is to be powered.

In another aspect of the present invention, a converter is connected, at a first side thereof, to a primary power supply. The primary power supply comprises, for instance, a household power supply provided at a household outlet plug receptacle. The converter is configured to convert the input energy of the primary power supply into first converted energy. When the household power supply comprises alternating-current energy of a relatively high voltage level, e.g., a hundred and ten volts, the converter operates both to convert the alternating-current energy into direct-current energy and also to down-convert the voltage level to a down-converted level.

In another aspect of the present invention, the converter provides a single output on a single output from the converter. That is to say, only a single power tap is made from the primary power source.

In another aspect of the present invention, the converter is housed in a converter housing. The converter housing includes a single input port at which input energy, sourced at a primary power source, is provided. And, the converter housing includes a single housing output, such as on a single output cable, at which converted energy is provided.

In another aspect of the present invention, a cable is connected at an output port of the converter housing. Energy of a first-converted energy level, converted by the converter of the converter housing is provided on the cable. The cable includes an adapter connected at an end, or other, side thereof. The adapter is configured to permit connection thereto alternately of a first connector tip, such as an MOMO tip, and a dongle. The adapter, configured to provide for connection of either the first connector or the dongle provides an adaptable mechanism by which to power a consumer electronic device or other electronic load. If a single loaded device is to be powered, the first connector tip, of a configuration permitting connection to the single load device, is connected to the adapter. The first connector tip, when connected to the adapter and to the load device provides operative power to the load device. Through appropriate selection of the characteristics of the converter, the power applied to the load device is of appropriate characteristics to provide for energy of desired characteristics to power the load device connected by way of the first connector tip and the adapter-tipped cable upon which the converted energy is provided.

In another aspect of the present invention, a dongle is provided, configured to be connectable to the adapter formed at the end, or other, side of the cable. The dongle provides a first output cable that passes through the first-converted energy provided to the dongle by way of its connection to the adapter and cable that extends from the converter housing and upon which the converted energy is provided by the converter. The cable extending beyond the dongle includes a first connector-tip permitting connection to the first load device. When connected to the first load device, the first connector tip, cable-connected to the dongle, provides operative power thereto.

In another aspect of the present invention, the dongle further provides additional energy conversion functionality to convert further the energy provided thereto. The converter of the dongle forms second-converted energy at an output port of the dongle. The second-converted energy is of characteristics to provide operative power to a second electronic device or other load element. The output port provides, e.g., for connection of a USB (Universal Serial Bus) connector that provides for connection to the second load device. Through appropriate selection of the conversion characteristics of the dongle, output energy is provided at the output port thereof of appropriate values to power the second load device.

Thereby, a mechanism is provided by which to provide operative power, to operate or to charge battery power supplies of, a set of electronic devices having different power characteristics. Only a single power tap is made directly from the primary power, i.e., input, source.

In these and other aspects, therefore, an apparatus, and an associated method, is provided for providing first-device operative power of a first output characteristic and second-device operative power of a second output characteristic. A converter housing has a first converter housed therein. The first converter is configured to convert input energy into converted energy of a converted energy characteristic. A dongle-adapter-tipped cable is connected at a first side of the cable to receive the converted energy of the converted energy characteristic provided by the converter. The dongle-adapter-tipped cable has a dongle adapter positioned a second side thereof. A dongle is connectable to the dongle adapter of the dongle-adapter-tipped cable. The dongle is adapted to receive the converted energy received at the first side of the dongle-adapter-tipped cable when connected to the dongle adapter. The dongle is configured to provide the first-device with operative power of the first output characteristic and to provide the second-device with operative power of the second output characteristic.

A more complete appreciation of the present invention and the scope thereof can be obtained from the accompanying drawings that are briefly summarized below, the following detailed description of the presently preferred embodiments of the present invention, and the appended claims.

### BRIEF DESCRIPTION OF THE DRAWINGS

FIG. 1 illustrates a functional block diagram of the converter of an embodiment of the present invention.

FIG. 2 illustrates a perspective view of the converter shown in FIG. 1 according to an embodiment of the present invention.

FIG. 3 illustrates another perspective view, similar to that shown in FIG. 2, but taken from a different angle.

FIG. 4 illustrates a plan view of the converter shown in the preceding figures.

FIG. 5 illustrates a perspective view of the converter of an embodiment of the present invention configured to provide operative power to a single load device.

### DETAILED DESCRIPTION

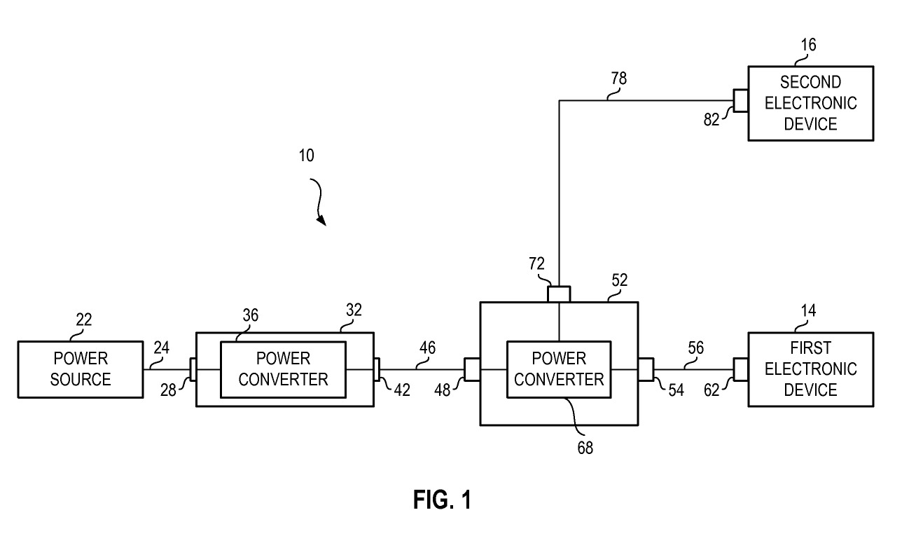

Turning first to FIG. 1, a converter, shown generally at 10, provides for the application of operative power to a set of load devices, here a first electronic device 14 and a second electronic device 16. In the exemplary implementation, the first electronic device and the second electronic device operate pursuant to operative power of different power characteristics. That is to say, the first electronic device 14 is operable pursuant to application of operating energy of first characteristics, and the second electronic device is operable pursuant to application of operating energy of second characteristics. By way of example, in one implementation, the first electronic device comprises a laptop computer that operates at 18 volts DC at 5 amperes, and the second electronic device comprises a portable, cellular phone, or other consumer electronic device that operates at 5 volts DC and 100 milliamperes. More generally, the first and second electronic devices 14 and 16 are representative of any of various load devices having different load characteristics and operable responsive to application of operating energy of different operating characteristics.

The converter is provided with input energy sourced at a power source 22, such as a household power supply available at a household power outlet. The input energy sourced at the power source 22 is provided to a cable 24 that, e.g., is placed in a plugged connection at a first end with a plug receptacle of the power source. The cable extends to an input port 28 positioned at an end side of a converter housing 32. The converter housing houses a converter 36 that is connected to receive the input energy sourced at the power source 22 and provided to the input port of the converter housing. The converter operates to convert the input energy into first-converted energy, which is provided to an output port 42 positioned at a second end side of the converter housing. The converter, in the exemplary implementation, operates to convert the input energy, of high-voltage, alternating-current characteristics into low-voltage, direct-current energy. The converter 36, in the exemplary implementation, converts the input energy into 18 volt, direct-current output energy.

A cable 46 extends beyond the output port 42. The cable is connected to the output port so that the cable 46 is provided with the first-converted energy formed by the converter 36. An adapter 48 is formed at a second end side of the cable 46. The adapter is of a configuration to permit connection of a dongle 52 in electrical connection with the adapter. And, as shall be noted below, the adapter 48 is further configured alternately to provide for connection with a plug tip (not shown in FIG. 1).

A cable 56 extends beyond the dongle 52. The cable 56 is maintained in electrical connection with the adapter 48 and, in turn, the cable 46 and the output port 42 at which the first-converted energy is provided when the dongle is connected at the adapter 48. When so-connected, the first-converted energy is also provided on the cable 56. A plug tip 62 is formed at a second end side of the cable 56. The plug tip 62 provides for connection with the first electronic device 14. When suitably connected to the first electronic device, first-converted energy converted by the converter 36 is provided to the electronic device. As the first-converted energy is of characteristics, in the exemplary implementation, configured to provide operative power to power the first electronic device, the connection of the plug tip into connection with the first electronic device causes powering of the device. The device, if turned-on, is operated. And, in the exemplary implementation in which the electronic device also includes a portable battery power supply, the operative power also, or alternately, provides recharging energy to recharge the stored energy of the battery power supply of the electronic device.

The dongle 52 further includes a converter 68 that is provided with the first-converted energy provided by way of the cable 46 and adapter 48 when the dongle is connected to the adapter. The converter 68 operates to convert the first-converted energy into second-converted energy. In the exemplary implementation, the second-converted energy comprises direct-current energy of a voltage value lower than the voltage of the first-converted energy. The second-converted energy formed by the converter 68 is provided to a dongle output port 72. The dongle output port in the exemplary implementation, forms a USB (Universal Serial Bus) port, which provides for connection of a USB connector thereto. The USB connector is tethered to a cable 78, which includes a connector 82 formed at a second end side of the cable 78. The connector 82, also, e.g., a USB connector provides for connection with the second electronic device 16. When suitably connected together, the second-converted energy provided by the converter 68 is provided to the second electronic device provide operative power thereto. Through appropriate configuration of the second converter 68, the second-converted energy is of characteristics suitable to provide the operative power for operation of the second electronic device. In the exemplary implementation in which the second electronic device also includes a battery power supply, the operative power provided to the second electronic device also, or alternately, is used to recharge the stored energy of the battery power supply.

Thereby, multiple electronic devices, here a set of electronic devices formed of the first and second electronic devices 14 and 16, are powered with converted energy while utilizing a converter that utilizes a single in-line power tap off of the input power supply.

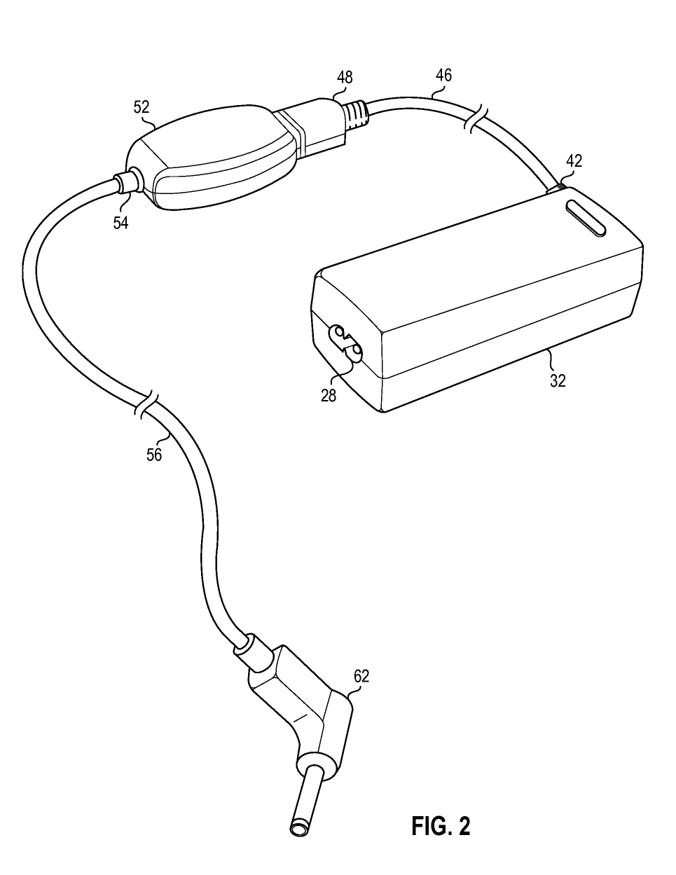

FIG. 2 again illustrates the converter 10. Here, the input port 28 formed at a first end side of the converter housing 32 is shown to comprise a dual-pronged plug receptacle configured to connect to a plug connector of the cable 24 (shown in FIG. 1) that provides input energy sourced at the power source 22 (also shown in FIG. 1). The converter housing is here shown to be of a generally rectangular configuration of a block-like form. And, the cable 46 is shown to extend beyond a second end side of the converter housing 32. The cable 46 positioned to extend beyond the second end side of the converter housing 32 includes the adapter 48 formed at an end thereof. The adapter provides for plugged connection to the dongle 52, here configured in the form of an elongated disc shape. And, the cable 56 is again shown to extend beyond the dongle 52 and include the connector 62, a plug tip, that provides for connection to a load device.

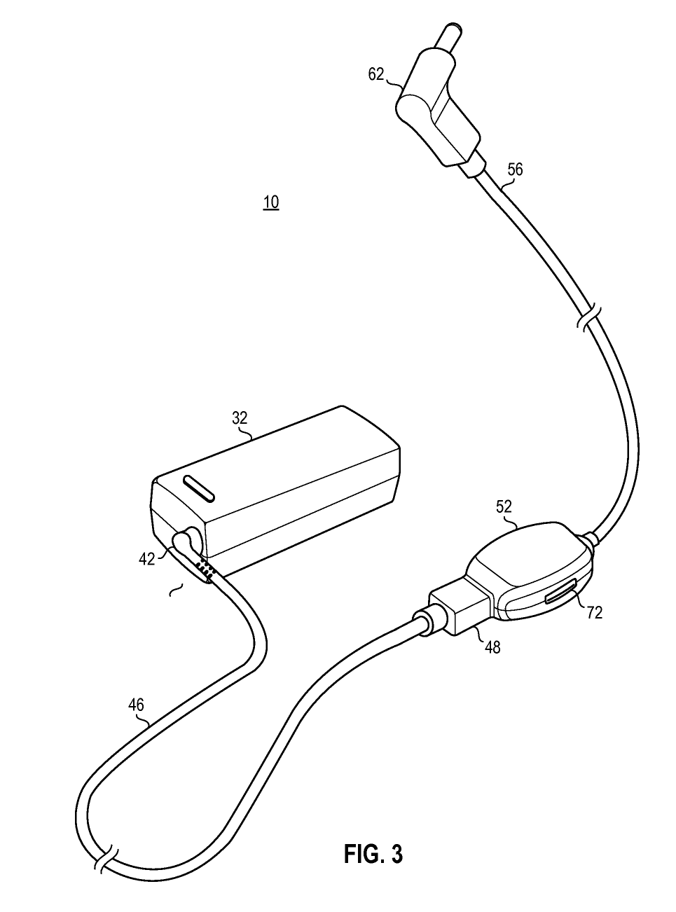

FIG. 3 also illustrates the converter 10, again showing the converter housing 32, the output port 42 beyond which the cable 46 extends, the adapter 48 formed at an end side of the cable 46 and the dongle 52 connected to the adapter 48 by way of a plugged connection therewith. The cable 56 is again shown to extend beyond the dongle 52 and to have the connector 62 formed at the end side thereof.

The view of FIG. 3 further illustrates the dongle output port 72 that here forms a USB port providing for connection thereto of a USB connector of the cable 78 (shown in FIG. 1). As described previously, first-converted energy provided to the dongle by way of the cable 46 at the adapter 48 is converted at the dongle into second-converted energy and provided at the dongle output port 72. The second-converted energy is of characteristics to provide for powering of the second electronic device 16 (shown in FIG. 1).

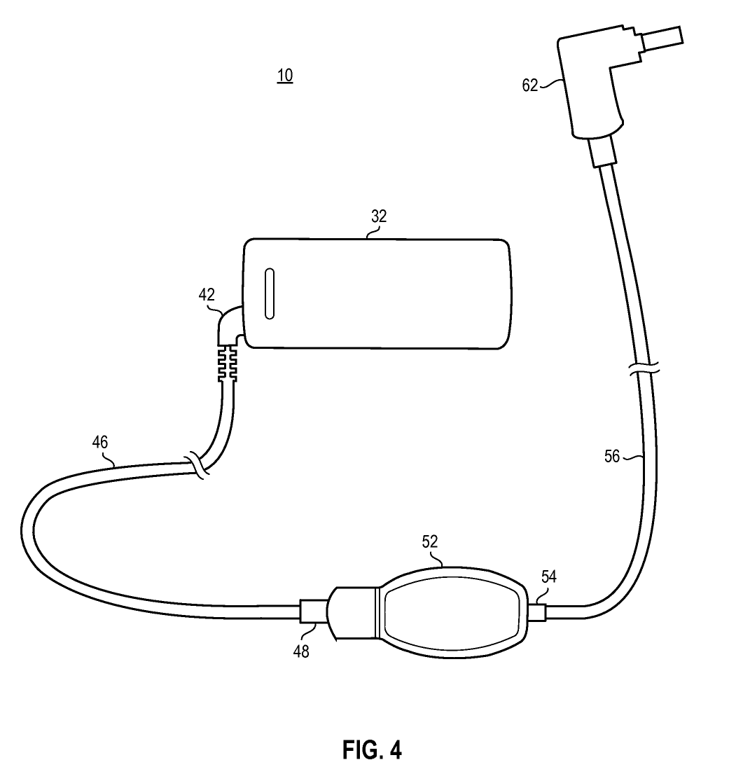

FIG. 4 again illustrates the converter 10, again showing the converter housing 32, and the cable 46 extending from the output port thereof. In this illustration, the cable 46 is shown to be fixably tethered to the output port 42 of the converter housing. Again, the adapter 48 is shown in connection with the dongle 52. And, the cable 56 with the plug tip formed at an end side thereof is again shown. First-converted energy is provided at the plug tip 62 to provide operative power to the first electronic device 14 (shown in FIG. 1). And, second-converted energy is provided at the dongle output port 72 to permit connection of the cable 78 (shown in FIG. 1) thereto and, in turn, powering of the second electronic device 16 (also shown in FIG. 1).

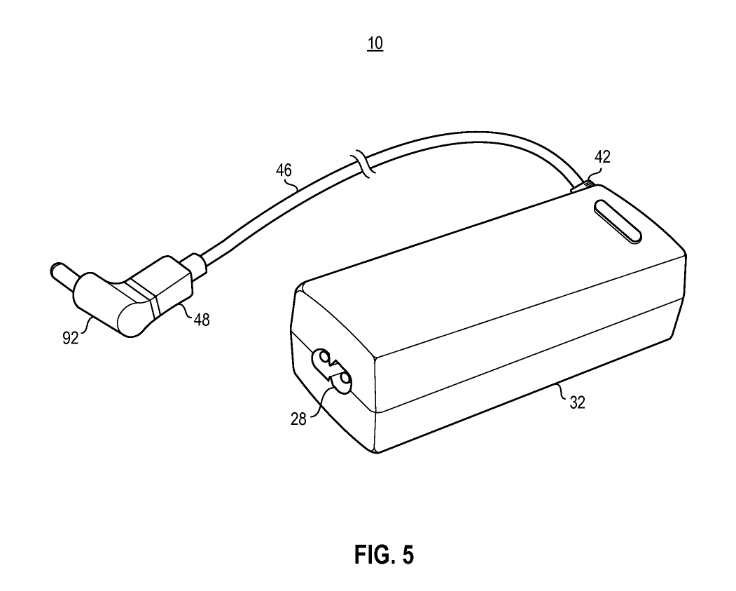

FIG. 5 also illustrates the converter 10, again showing the converter housing 32 the input port 28 thereof, and the cable 46 extending from the output port 42 of the converter housing. In this illustration, the adapter 48 is connected to a plug tip 92 that provides for connection to the first electronic device 14 (shown in FIG. 1). Here, when there is no need to provide operative power to a second electronic device, the first-converted energy provided at the output port 42 of the converter housing 32 is provided at the adapter 48 and, in turn, to the plug tip 92. Powering of the first electronic device 14 is provided when suitably connected to the plug tip.

FIG. 6 illustrates a method flow diagram, shown generally at 102, representative of the method of operation of an embodiment of the present invention. The method provides first-device operative power of a first output characteristic and second-device operative power of a second output characteristic.

First, and as indicated by the block 104, input energy is converted into converted energy of a converted energy characteristic at a converter housed at a converter housing. Then, and as indicated by the block 106, the converted energy is provided to a first side of a dongle-adapter-tipped cable. And, as indicated by the block 108, a dongle is connected to the adapter. The dongle is connected in-line with the converter housed at the converter housing. The dongle has both a first output element and a second output element that provides the first-device operative power and the second-device operative power.

Then, and as indicated by the block 112, a first electronic device is connected to the first output element of the dongle to provide the first electronic device with the first device operative power of the first output characteristic. And, as indicated by the block 115, a second electronic device is connected to the second output element of the dongle to provide the second electronic device with second-device operative power of the second output characteristic.

Thereby, the converter provides operative power to power a set of electronic devices while requiring only a single output off of a main power supply.

Presently preferred embodiments of the disclosure and many of its improvements have been described with a degree of particularity. The description is of preferred examples of implementing the disclosure, and the description of preferred examples is not necessarily intended to limit the scope of the disclosure. The scope of the disclosure is defined by the following claims.

What is claimed is:

1. An apparatus for providing first-device operative power of a first output characteristic and second-device operative power of a second output characteristic, said apparatus comprising:
a converter housing having a first converter housed therein, the first converter configured to convert input energy into converted energy of a converted energy characteristic;
a dongle-adapter-tipped cable connected at a first side of the cable to receive the converted energy of the converted energy characteristic provided by said converter, the dongle-adapter-tipped cable having a dongle adapter positioned at a second side thereof; and
a dongle connectable to the dongle adapter of said dongle-adapter-tipped cable and adapted to receive the converted energy received at the first side of the dongle-adapter-tipped cable and adapted to receive the converted energy received at the first side of the dongle-adapter-tipped cable when connected to the dongle adapter, said dongle configured to provide the first-device operative power of the first output characteristic and to provide the second-device operative power of the second output characteristic.

2. The apparatus of claim 1 wherein the first-device operative power of the first output characteristic comprises a voltage level substantially corresponding to a voltage level of the converted energy.

3. The apparatus of claim 1 wherein the second-device operative power of the second output characteristic comprises a voltage level less than a voltage level of the converted energy.

4. The apparatus of claim 1 wherein said dongle is configured concurrently to provide the first-device operative power of the first characteristic and the second-device operative power of the second characteristic.

5. The apparatus of claim 1 wherein said dongle further comprises a second converter said second converter configured to step-down the converted energy to form the second-device operative power, the second-device operative power of a stepped-down energy characteristic.

6. The apparatus of claim 5 wherein said dongle further comprises a connector socket connected to receive the second-device operative power provided by said second converter.

7. The apparatus of claim 1 wherein said dongle comprises a first output element configured to provide the first-device operative power and a second output element configured to provide the second-device operative power.

8. The apparatus of claim 7 wherein the first output element of said dongle comprises a connector plug.

9. The apparatus of claim 7 wherein the second output element of said dongle comprises a connector socket.

10. The apparatus of claim 1 wherein said dongle is releasably connectable to the dongle adapter of said dongle-adapter-tipped cable.

11. The apparatus of claim 1 wherein said converter housing further comprises a single converted-energy output port provided with the converted energy of the converted energy characteristic.

12. The apparatus of claim 1 wherein said dongle comprises an in-line power tap, positioned in-line with said converter housing and the converter housed therein.

13. A method for providing first-device operative power of a first output characteristic and second-device operative power of a second output characteristic, said method comprising:
converting input energy into converted energy of a converted energy characteristic at a converter housed at a converter housing;
providing the converted energy to a first side of a dongle-adapter-tipped cable and, thereby, to a dongle adapter positioned at a second side of the dongle-adapter-tipped cable; and
connecting a dongle to the dongle adapter, in-line with the converter housed, at the converter housing, the dongle having both a first output element and a second output element that provides the first-device operative power and the second-device operative power.

14. The method of claim 13 further comprising connecting a first electronic device to the first output element of the dongle to provide the first electronic device with the first-device operative power of the first output characteristic.

15. The method of claim 14 further comprising connecting a second electronic device to the second output element of the dongle to provide the second electronic device with second-device operative power of the second output characteristic.

16. The method of claim 15 further comprising concurrently powering both the first electronic device and the second electronic device.

17. The method of claim 13 wherein said connecting the dongle further comprises down-converting the converted energy to form the second-device operative power of the second output characteristic.

18. An apparatus for providing operative power to at least one of a first electronic device and a second electronic device and a second electronic device, said apparatus comprising:
a converter housing having a first converter housed therein, the first converter housed therein configured to convert input energy into converted energy of a converted energy characteristic;
an adapter connected at a first side thereof to said converter housing and configured to receive the converted energy provided by the converter; and
an adapter connected to a second side of said adapter cable, said adapter configured to connect to one of:
a first-electronic-device plug of configuration permitting connection to the first electronic device; and
a dongle having a first output element permitting connection to the first electronic device and a second output element permitting connection to the second electronic device.

19. The apparatus of claim 18 wherein the first output element of said dongle comprises a plug connector.

20. The apparatus of claim 18 wherein the second output element of said dongle comprises a plug socket.
